(19) United States
(12) Patent Application Publication
(10) Pub. No.: US 2003/0185227 A1
(43) Pub. Date: Oct. 2, 2003

(54) Secondary queue for sequential processing of related queue elements

(75) Inventors: Cuong M. Le, Tucson, AZ (US); Anthony S. Pearson, Tucson, AZ (US); Glenn R. Wilcock, Tucson, AZ (US)

Correspondence Address: Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 10/112,240

(22) Filed: Mar. 29, 2002

(51) Int. Cl. H04L 12/54

(52) U.S. Cl. 370/429; 370/411

(57) ABSTRACT

A queue management system and a method of managing a queue. The queue management system includes primary and secondary queues for storing messages, and a processor for determining on which queue to place received messages. This processor means includes (i) means for receiving messages, and (ii) means for determining, for each received message, whether the message is logically related, according to a predefined relationship, to one of the messages stored on the primary queue. If the received message is logically related to one of the messages stored on the primary queue, then placing the received message on the secondary queue; and if the received message is not logically related to one of the messages stored on the primary queue, then placing the received message on the primary queue. Preferably, the processor means further includes means for maintaining, for each of at least some of the messages on the primary queue, a list of messages on the secondary queue that are logically related, according to the predefined relationship, to said each message. Also, preferably, the processor means further includes means for maintains an object list identifying the messages on the primary queue, and the means for determining whether the received message is on the primary queue includes means to determine if the received message is listed on the object list.

### BACKGROUND OF THE INVENTION

1. Technical Field

The present invention relates generally to parallel processing environments, and more specifically to a shared queue for a multi-processor environment.

2. Background Art

It is commonplace in contemporary data processing environments to provide a plurality of systems to handle the processing needs of one or more clients. For example, two or more systems, such as transaction processing systems, may be interfaced to one or more clients via a communications network. In this environment, when a client has a task to be performed by one of the systems, that client sends an input message to the desired system to request processing by an application running in that system. The subject system queues the message and provides the message to the application for processing. When processing is complete, the application places an outgoing message in the queue for transmission over the network to the client.

To take advantage of the multi-processing aspect of this environment, the system originally tasked by the client, system A, may extract the input message from its queue and forward the input message to a second system, system B, for processing. When processing is completed by system B, the response (outgoing message) is forwarded to system A and placed on system A's queue for transmission to the client. Thus, in this manner, multiple systems can be utilized to handle processing requests from numerous clients.

There are, however, a few disadvantages with this arrangement. For example, if system A fails, none of the work on the queue of system A can be accessed. Therefore, the client is forced to wait until system A is brought back online to have its transaction processed.

In order to address these disadvantages, a shared, or common, queue may be provided to store incoming messages for processing by any of a plurality of data processing systems. A common queue server receives and queues the messages onto the shared queue so that they can be retrieved by a system having available capacity to process the messages. In operation, a system having available capacity retrieves a queued message, performs the necessary processing, and places an appropriate response message back on the shared queue. Thus, the shared queue stores messages sent in either direction between clients requesting processing and the data processing systems that perform the processing.

Because the messages are enqueued onto the shared queue, the messages can be processed by an application running in any of a plurality of systems having access to the shared queue. Thus, automatic workload management among the plurality of systems is provided. Also, because any of the systems connected to the shared queue can process messages, an advantage of processing redundancy is provided. If a particular application that is processing a message fails, another application can retrieve that message from the shared queue and perform the processing without the client having to wait for the original application to be brought back on-line. This provides processing redundancy to clients of the data processing environment.

In systems that implement a queue to process work requests, queue entries are generally placed on the queue in FIFO in order or according to some designated priority. When a work request is being selected, the processor simply removes an entry from the Head/Tail of the queue. In certain work queue environments, there may be queue entries that require a “costly” resource. That is, the cost of obtaining the resource is high when compared to the cost of processing the request. Thus, once that resource is obtained, it is desirable to utilize that resource to the fullest possible extent before relinquishing it. An example of this is a tape resource. To acquire a tape resource requires the allocation of a tape unit followed by the allocation of the tape itself. Once the resource is obtained, it is desirable to process all outstanding work requests that require that resource. Doing so distributes the cost of acquiring the resource. But, this introduces the overhead of extra I/O, serialization and search time in order to scan the queue in a nonstandard sequence.

In some existing systems, when a second work request related to a particular tape is being searched for, the entire work queue may have to be scanned. During this scan, all tasks assigned to process work requests from the work queue are locked out until the task that is scanning for requests has completed its search. Having each task lock the queue while it scans the entire queue for another request is not efficient, and may be impractical or even unfeasible, due to the increased contention for the same queue and the increased queue length.

### SUMMARY OF THE INVENTION

An object of this invention is to improve data processing systems that use a queue to process work requests.

Another object of the present invention is to provide a mechanism, in systems that implement a queue to process work request, that provides immediate access to the next request to be processed that is related to a particular object.

A further object of this invention is to use a pair of queues in combination to sequentially process logically related queue entries.

These and other objectives are attained with a queue management system and a method of managing a queue. The queue management system includes primary and secondary queues for storing messages, and a processor means for determining on which queue to place a message. This processor means includes (i) means for receiving messages, and (ii) means for determining, for each received message, whether the message is logically related, according to a predefined relationship, to one of the messages stored on the primary queue. If the received message is logically related to one of the messages stored on the primary queue, then the received message is placed on the secondary queue; however, if the received message is not logically related to one of the messages stored on the primary queue, then the received message is placed on the primary queue.

Preferably, the processor means further includes means for maintaining, for each of at least some of the messages on the primary queue, a list of messages on the secondary queue that are logically related, according to the predefined relationship, to said each message. Also, preferably, the processor means further includes means maintaining object list identifying the messages on the primary queue, and the means for determining whether the received message is on the primary queue includes means to determine if the received message is listed on the object list.

Further benefits and advantages of the invention will become apparent from a consideration of the following detailed description, given with reference to the accompanying drawings which specify and show preferred embodiments of the invention.

### BRIEF DESCRIPTION OF THE DRAWINGS

FIG. 1 is a block diagram showing a shared queue in a client/server environment.

FIG. 2 illustrates secondary queues that may be provided for use with primary queues in the environment of FIG. 1.

FIG. 3 outlines a procedure for using the secondary queue shown in FIG. 2.

FIG. 4 shows a procedure for determining whether requests are placed in a primary queue or a secondary queue.

### DETAILED DESCRIPTION OF THE PREFERRED EMBODIMENTS

The present invention generally relates to systems and methods that may allow any of a plurality of processing systems to process messages for one or more clients. In the preferred embodiment, a structured external storage device, such as a shared queue, is provided for queuing client messages for the plurality of systems. When incoming messages are received from the clients, they are placed on the queue. When one of the plurality of systems has available processing capacity, it retrieves a message, processes the message and places a response on the queue.

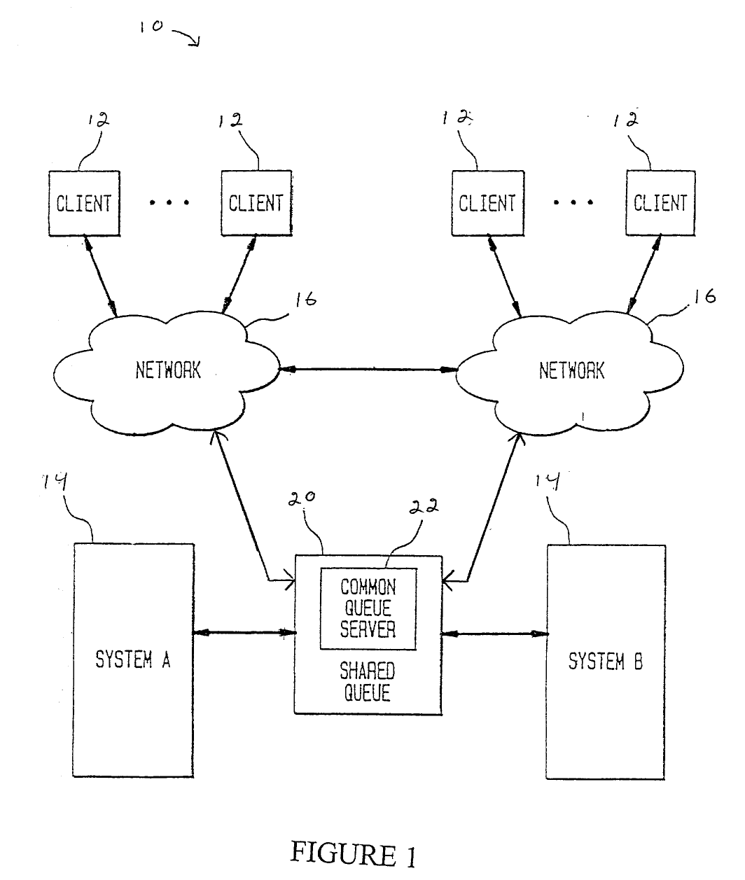

FIG. 1 is a block diagram illustrating the shared queue in a client/server environment 10. The client/server environment includes one or more clients 12 interfaced to a plurality of processing systems 14 via one or more networks 16. When a client 12 has a transaction to be processed, the client enqueues the message onto shared queue 20. As additional messages are received from clients, they too are enqueued onto the shared queue. Each message remains on shared queue 20 until it is retrieved by one of the systems 14 for processing.

When a system 14 determines that it has the capacity to process another transaction, that system 14 dequeues a message from shared queue 20. That system 14 then processes the message and places on shared queue 20 the appropriate response to the client that generated the incoming message. A common queue server 22 provides the necessary interface between shared queue 20 and systems 14. When an input message is received by common queue server 22 for enqueueing onto shared queue 20, the queue server buffers the message in one or more buffers and then transfers this data to the shared queue. Any suitable common queue and common queue server may be used in the practice of this invention.

As discussed above, one difficulty that can occur when a shared queue is used is that resources may not be used in the most efficient way. More specifically, as discussed above, once a resource is obtained to process a request, it is desirable to utilize that resource to the furthest possible extent.

In order to achieve this, the present invention uses a feature referred to as a secondary queue. Instead of placing all work requests onto a single queue, the first or highest priority request that requires a costly resource is placed on a primary queue, but subsequent related requests are placed on a secondary queue such that they can be easily selected. When a processor selects a request from the primary queue that requires a costly resource, and that resource has been obtained, it can quickly find subsequent requests for the same resource on the secondary queue. This has the benefit of reducing the overhead of selecting another request that requires the same resource. It should be noted that this principal is not limited to having a secondary queue just for costly resources. It can be used by any application that needs to sequentially process logically related queue entries that should not be placed on the work queue in sequential order for the purpose of operation efficiency.

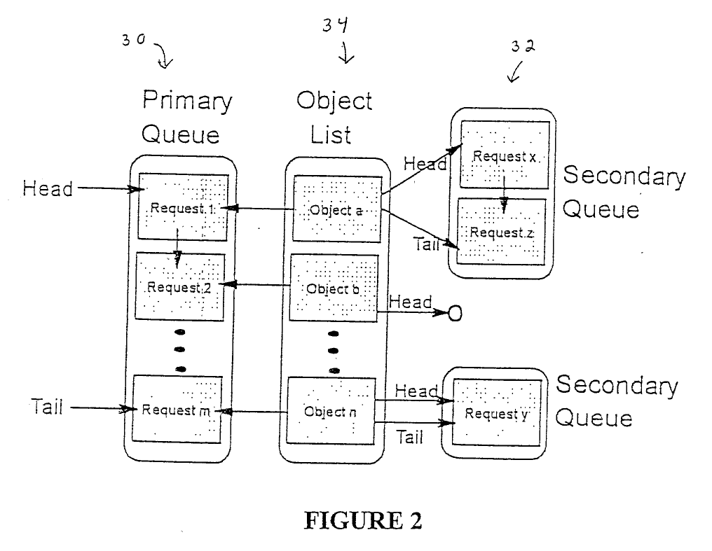

With reference to FIG. 2, there are three components to this aspect of the invention: the primary queue 30, the secondary queue 32, and the object list 34. The primary queue 30 is the main queue used for placing and selecting work requests. The secondary queue 32 is used for placing and selecting work requests that are logically related to a request (requires same object resource) already contained on the primary queue. The object list 34 is used to manage which queue a new request is placed on.

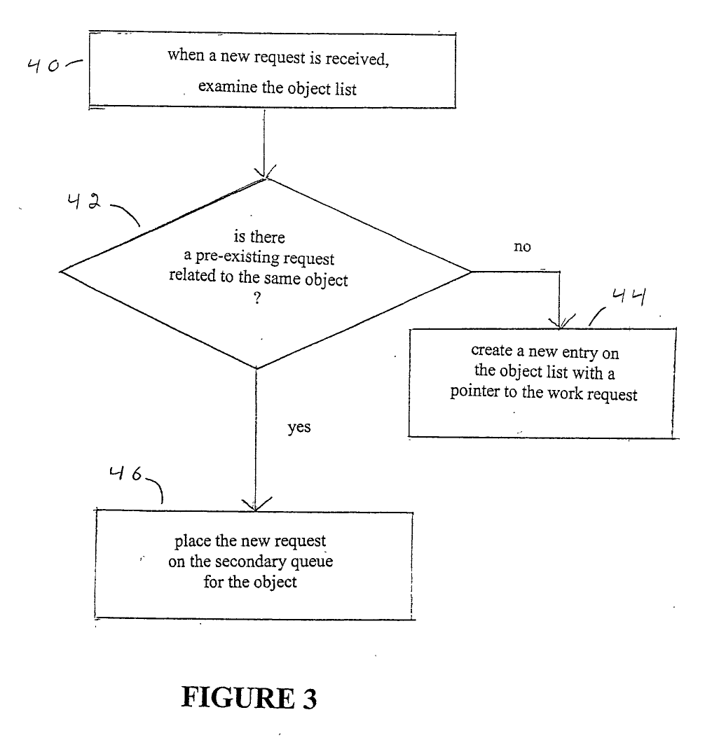

With reference to FIG. 3, when a new work request is received, at step 40, the object list is examined to determine if there are preexisting requests related to the same object, as represented at step 42. If there are none, then at step 44 a new entry is created on the object list with a reference, such as a pointer, to the work request. The request is placed onto the primary queue using the standard placement technique (FIFO or other). If, however, there is an existing entry in the object list, then (FIFO logic used to place new requests) at step 46 the new request is placed on the secondary queue for the object.

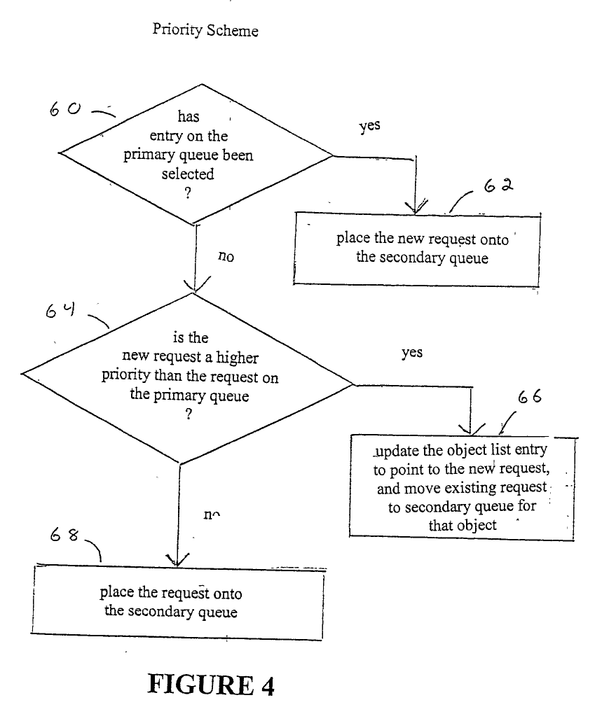

FIG. 4 shows a priority scheme that may be used to place new requests. As represented at steps 60 and 62, if the entry on the primary queue has already been selected, then the request is placed onto the secondary queue in priority order. If the entry on the primary queue has not yet been selected, then, as represented by step 64, the procedure depends on whether the new request is or is not a higher priority than the request on the primary queue. Specifically, if the new request is a higher priority than the request on the primary queue, then the object list entry is updated at step 66 to point to the new request. Also, the new request is placed onto the primary queue in priority order, and the original request is moved from the primary queue to the secondary queue in priority order. However, if the new request is a lower or equal priority to the request on the primary queue, then at step 68 the new request is placed onto the secondary queue in priority order.

When selecting a work to process, the processor selects the highest priority request from the primary queue. After processing the initial request, the processor determines if there are other requests related to the same object as the initial request by examining the secondary queue for that object. If there are, then those requests are processed. After processing all requests from the secondary queue, the object is removed from the object list to indicate that all requests related to that object have been processed.

The processing needed to determine whether a received message is placed on the primary or secondary queue, and to maintain and use the above-discussed object list, may be performed by any suitable processor means. For instance, the queue server 22 may be used to perform these functions, one or more of the processing systems 14 may be used to perform the desired processing, or a separate device may be provided for this purpose. Also, depending on the specific environment in which the present invention is employed, this processor means may include a single processor or plural processor. For instance, depending on the specific system in which the invention is used, a personal computer having a single-processing unit, or any other suitable type of computer, including, for instance, computers having plural or multiple processor units may be used to determine on which queue to place a message, and to operate and use the object list. Further, it may be noted, the needed processing may be done principally by software, or if desired principally by hardware, or by a combination of software and hardware.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A queue management system comprising:
a primary queue for storing messages;
a secondary queue for storing messages;
a processor means including
i) means for receiving messages, and
ii) means for determining, for each received message, whether the message is logically related, according to a predefined relationship, to one of the messages stored on the primary queue; and if the received message is logically related to one of the messages stored on the primary queue, then placing the received message on the secondary queue; and if the received message is not logically related to one of the messages stored on the primary queue, then placing the received message on the primary queue.

2. A queue management system according to claim 1, wherein the processor means further includes means for maintaining, for each of at least some of the messages on the primary queue, a list of messages on the secondary queue that are logically related, according to the predefined relationship, to said each message.

3. A queue management system according to claim 2, wherein the processor means further includes means maintaining an object list identifying the messages on the primary queue.

4. A queue management system according to claim 3, wherein the means for determining include means for determining, for each received message, whether the received message is on the primary queue.

5. A queue management system according to claim 4, wherein the means for determining whether the received message is on the primary queue includes means to determine if the received message is listed on the object list.

6. A queue management system according to claim 2, wherein the object list identifies, for each message on the primary queue identified on the object list, messages on the secondary queue that are logically related to said each message according to the predefined relationship.

7. A method of managing a queue comprising:
storing a second set of messages in a secondary queue;
running a data processing application program on a processor means to determine whether messages received by the processor means are placed on the primary queue or the secondary queue, including the steps of
i) determining, for each received message, whether the message is logically related, according to a predefined relationship, to one of the messages stored on the primary queue, and
ii) if the received message is logically related to one of the messages stored on the primary queue, then placing the received message on the secondary queue; and if the received message is not logically related to one of the messages stored on the primary queue, then placing the received message on the primary queue.

8. A method according to claim 7, wherein the step of running the data processing program further includes the step of maintaining, for each of at least some of the messages on the primary queue, a list of messages on the secondary queue that are logically related, according to the predefined relationship, to said each of some of the message.

9. A method according to claim 8, further comprising the step of maintaining an object list identifying the messages on the primary queue.

10. A method according to claim 9, wherein the determining step include the step of determining, for each received message, whether the received message is on the primary queue.

11. A method according to claim 10, wherein the object list identifies, for each message on the primary queue identified on the object list, messages on the secondary queue that are logically related to said each message according to the predefined relationship.

12. A program storage device readable by machine, tangibly embodying a program of instructions executable by the machine to perform method steps for managing a queue, said method steps comprising:
storing a first set of messages in a primary queue;
storing a second set of messages in a secondary queue;
operating a processor means to determine whether messages received by the processor means are placed on the primary queue or the secondary queue, including the steps of
i) determining, for each received message, whether the message is logically related, according to a predefined relationship, to one of the messages stored on the primary queue,
ii) if the received message is logically related to one of the messages stored on the primary queue, then placing the received message on the secondary queue; and if the received message is not logically related to one of the messages stored on the primary queue, then placing the received message on the primary queue.

13. A program storage device according to claim 12, wherein the step of operating the processor further includes the step of maintaining, for each of at least some of the messages on the primary queue, a list of messages on the secondary queue that are logically related, according to the predefined relationship, to said each of some of the message.

14. A program storage device according to claim 13, wherein said method steps further comprise the step of maintaining an object list identifying the messages on the primary queue.

15. A program storage device according to claim 14, wherein the determining step include the step of determining, for each received message, whether the received message is on the primary queue.

16. A program storage device according to claim 15, wherein the object list identifies, for each message on the primary queue identified on the object list, messages on the secondary queue that are logically related to said each message according to the predefined relationship.

17. A data processing system comprising:
a primary queue for storing a first group of messages;
a secondary queue for storing a second group of messages;
a processor means, including
i) means for receiving messages,
ii) means for determining, for each received message, whether the message is logically related, according to a predefined relationship, to one of the messages stored on the primary queue; and if the received message is logically related to one of the messages stored on the primary queue, then placing the received message on the secondary queue; and if the received message is not logically related to one of the messages stored on the primary queue, then placing the received message on the primary queue, and
iii) means for maintaining, for each of at least some of the messages on the primary queue, a list of messages on the secondary queue that are logically related, according to the predefined relationship, to said each message.

18. A data processing system according to claim 17, further comprising means maintaining an object list identifying the messages on the primary queue, and wherein the means for determining whether the received message is on the primary queue includes means to determine if the received message is listed on the object list.
